(19) United States
(12) Patent Application Publication
(10) Pub. No.: US 2004/0174531 A1
(43) Pub. Date: Sep. 9, 2004

(54) System for interferometric fit testing

(75) Inventor: Rolf Freimann, Aalen (DE)

Correspondence Address: WELSH & KATZ, LTD, 120 S RIVERSIDE PLAZA, 22ND FLOOR, CHICAGO, IL, 60606, US

(73) Assignee: Carl Zeiss SMT AG, Oberkochen (DE)

(21) Appl. No.: 10/731,697

(22) Filed: Dec. 9, 2003

(30) Foreign Application Priority Data
Dec. 13, 2002 (DE) 102 58 248.3

(51) Int. Cl. G01B 9/021

(52) U.S. Cl. 356/512; 356/458

(57) ABSTRACT

A system for interferometric fit testing of a specimen having an aspherical surface in reflection, the specimen being a segment (2) (footprint) of a rotationally symmetrical basic body (1) (parent), comprises an interferometer (3) and a diffractive optical element (DOE) (5). An optical axis of the interferometer (3) in the beam direction behind the diffractive optical element (5) and an axis of rotation of the basic body (1) form an angle that differs from zero. The diffractive optical element (5) is designed in such a way that the rays produced by the interferometer (3) and falling into the diffractive optical element (5) strike the specimen (2) perpendicularly and from there run back in themselves.

The invention relates to a system for interferometric fit testing of a specimen having an aspherical surface in reflection, the specimen being a segment (footprint) of a rotationally symmetrical basic body (parent), comprising an interferometer and a diffractive optical element (DOE).

A system for interferometric fit testing of a specimen having an aspherical surface is already known. Refractive and diffractive elements are used in the testing. The errors present in the system, which are caused by their refractive components, are determined by means of the calibration with a known calibration mirror. In this case, the diffractive optical element is used in the zeroth order of diffraction. According to said system, the aspheric specimen is measured in autocollimation, after which all the errors of the refractive system parts are either subtracted from the measured result or eliminated during the aspherical testing. Here, the testing is carried out for rotationally symmetrical specimens. In this case, the axis of rotation coincides with the optical axis. In this way, absolute measurement of non-rotationally symmetrical aspheric errors is possible even in the event of unknown interferometer errors, that is to say in accordance with the published rotational averaging method from “Absolute measurement of non-comatic aspheric surface errors; R. Freimann, B. Dörband, F. Höller, Optics Communications 161 (1999) pp. 106-114 or in accordance with the extension described in DE 100 58 650 A1.

Furthermore, measurement methods are known for aspheric surfaces, in particular for those which are used as mirrors in EUV lithography and which operate in a similar way, as already specified. The disadvantage in the case of these measurement methods, however, is that rotationally symmetrical aspheric fit errors remain undetected.

In relation to the prior art, reference is made to DE 100 41 658, U.S. Ser. No. 2001/0028462 A1 and to U.S. Pat. No. 6,312,373 B1.

The present invention is therefore based on the object of providing a test arrangement for EUVL asphere footprints with which it is possible to determine asphere fit errors which are rotationally symmetrical with respect to the rotationally symmetrical base body (parent) and which are difficult to determine with the compensation systems already known.

According to the invention, this object is achieved by the features recited in claims 1, 14, 18 and 24.

According to the invention, in order to test the fit, the specimen (footprint) is placed in reflection in the beam path of the interferometer, in which there are likewise a reference surface and a diffractive optical element (DOE). The diffractive optical element, which is advantageously fabricated as a computer generated hologram (CGH), is necessary in order that the test wave strikes every point of the aspheric specimen perpendicularly. Before the fit testing, care should advantageously be taken that the non-rotationally symmetrical interferometer errors are determined and do not falsify the measured result during the measurement of the specimen.

In this measurement method, the substantial advantage is that the rotationally symmetrical asphere errors with respect to the basic shape (parent) appear as non-rotationally symmetrical here and can thus be determined substantially more accurately than with the standard measurement methods already known.

The core of the method is to be seen in the fact that the optical axis of the interferometer is not parallel with the axis of rotation of the basic shape but forms with it an angle that differs from zero. The spatial arrangement of the two axes leads to rotationally symmetrical asphere errors with respect to the basic shape appearing in the interferometer as non-rotationally symmetrical with respect to the axis of the latter. Using the standard methods cited, non-rotationally symmetrical interferometer errors with respect to the interferometer axis can be determined. As a result, the measurement of errors of the specimen (footprint) which are non-rotationally symmetrical with respect to the interferometer axis is possible very accurately. By means of the method according to the invention, the measurement accuracy is transferred to the rotationally symmetrical asphere errors with respect to the basic shape.

If a level output wave is used, it is advantageous for the test wave to strike the diffractive optical element at a specific angle and thus back-reflections can be masked out better.

Furthermore, provision can advantageously be made for the wave striking the CGH of the diffractive optical element to be provided as a spherical wave, a refractive front-end optical system being provided between the reference surface and the diffractive optical element.

If a spherical wave is used instead of a planar wave, there should be a front-end optical system for CGH illumination for producing the spherical wave between the reference surface and the diffractive optical element.

Exemplary embodiments of the invention will be explained in more detail below using the drawing, in which:

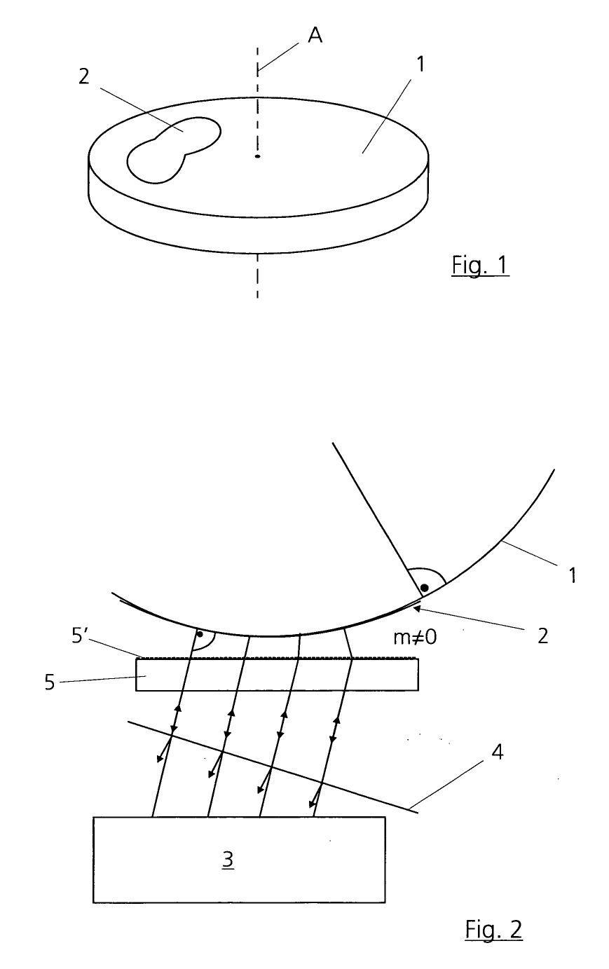

FIG. 1 shows a basic illustration of a basic shape, a specimen representing a segment of the basic shape;

FIG. 2 shows an illustration of the principle of the test arrangement for measuring rotationally symmetrical asphere fit errors of the basic shape by means of an interferometer that sends out a planar wave;

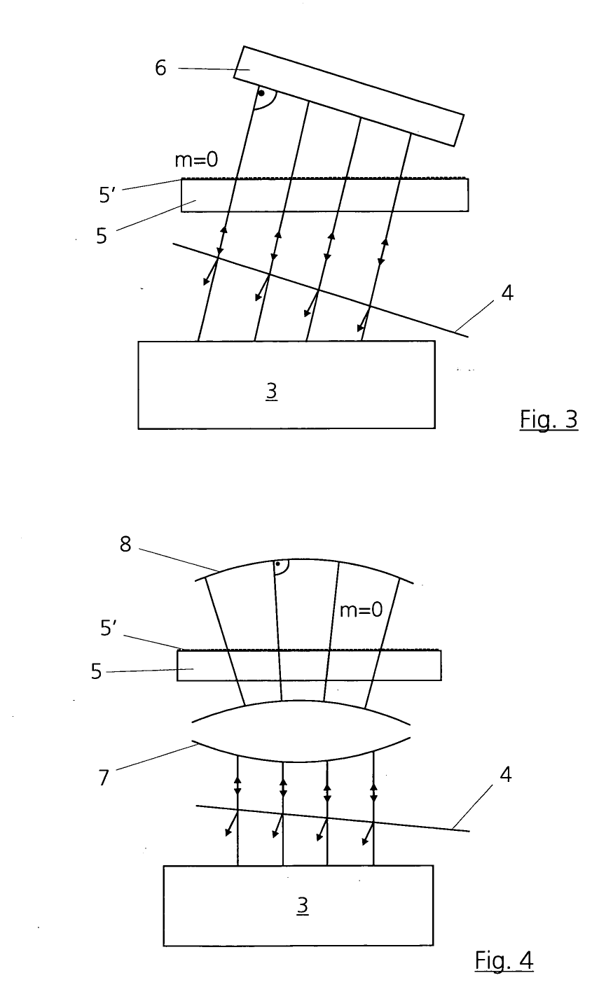

FIG. 3 shows an illustration of the principle of the calibration of the non-rotationally symmetrical interferometer errors via a planar surface as preliminary work for measuring the rotationally symmetrical asphere fit errors of the basic shape described in FIG. 2;

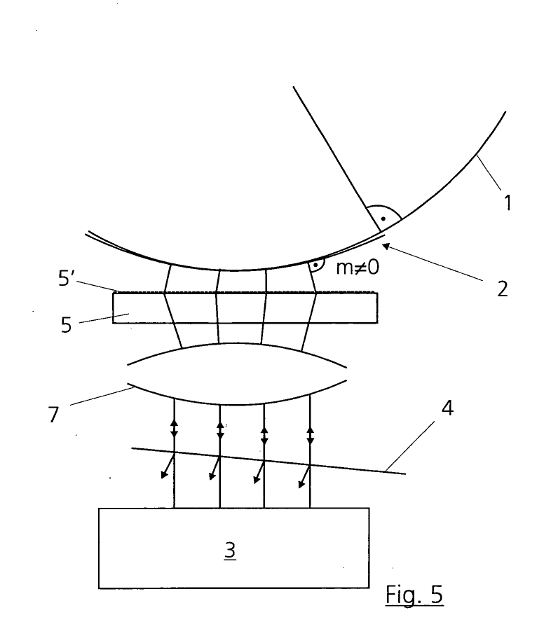

FIG. 4 shows an illustration of the principle of the calibration of the non-rotationally symmetrical interferometer errors over a spherical surface as preliminary work for measuring the rotationally symmetrical asphere fit errors of the basic shape described in FIG. 5; and

FIG. 5 shows an illustration of the principle of an alternative test arrangement for measuring rotationally symmetrical asphere fit errors of the basic shape by means of a spherical wave.

FIG. 1 shows an aspheric basic shape 1, an axis of rotation (not illustrated) and an optical axis A coinciding, since the basic shape 1 is of rotationally symmetrical design. Since the complete basic shape, which is also called a “parent”, is not needed in EUVL optics, only a requisite segment 2, which is also designated a “footprint”, is fabricated. These are off-axis segments.

FIG. 2 illustrates a test arrangement for measuring rotationally symmetrical asphere fit errors of the basic shape 1. For the purpose of interferometric testing of the footprint 2, an interferometer 3 with a flat output wave is needed. A reference surface 4, which should be planar, is located between the footprint 2 and the interferometer 3. The reference surface reflects part of the planar wave and thus forms the reference wave for the interferometer 3. The bundle of light which, for example, is produced by a laser, which is not illustrated here, from the reference surface 4 strikes a diffractive optical element 5, which is advantageously written as a computer generated hologram (CGH). The CGH 5′ shapes the planar wave in such a way that the rays strike the footprint perpendicularly everywhere and, in the case of a satisfactorily adjusted footprint 2, run back in themselves.

Furthermore, the parent 1 is partly illustrated in figure 2, but is used only for illustration, since it is not present in actual fact. The optical axis 3 of the imaginary parent 1 and the optical axis of the interferometer 3, which is not illustrated, thus do not coincide.

The laser used is advantageously a frequency-stabilized laser whose wavelength is known very accurately. In addition, the current laser wavelength can be measured via a wavelength measuring instrument.

The planar wave falling on the CGH 5′ strikes the diffractive optical element 5 at an angle, in order to be able to mask out back-reflections better. The errors of the CGH substrate 5 in passage can be measured in absolute terms in the zeroth order of diffraction in a planar testing station before the application of the CGH 5′ or else thereafter and are thus known. Furthermore, before the measurement, the non-rotationally symmetrical reference surface errors of the flat reference surface 4 can be measured in absolute terms on a standard planar wave interferometer by using the rotational averaging method known and cited above. After that, the off-axis footprint 2 is moved into the beam path of the interferometer 3 and adjusted correctly. The footprint 2 now has rotationally symmetrical errors with respect to the parent 1. However, with respect to the footprint 2, these are not rotationally symmetrical. Since the non-rotationally symmetrical errors of the interferometer 3 have been qualified before the measurement, they can now be separated from the non-rotationally symmetrical errors of the parent 1.

The solution according to the invention therefore consists in the fact that, by circumventing the rotational symmetry of the parent 1, the asphere fit errors which are rotationally symmetrical in relation to said parent can be measured very accurately as non-rotationally symmetrical fit errors.

The calibration of the measuring arrangement described in FIG. 2 is illustrated in FIG. 3. Before the measurement of the aspherical footprint 1, the interferometer 3 is calibrated in the zeroth order of diffraction with the planar plate 6. The planar plate 6 can either be qualified in advance in absolute terms by another method or the rotational averaging method cited is used in order to determine the non-rotationally symmetrical errors of the interferometer 3 in this way. After that, as described under FIG. 2, the footprint 2 can be measured with respect to the rotationally symmetrical errors of the parent 1, which appear as non-rotationally symmetrical on the footprint 2.

In an alternative test arrangement, as illustrated in FIG. 4, the CGH 5′ can be illuminated through the substrate 5 with a spherical wave. For this purpose, a refractive front-end optical system 7 is used, which is described extensively in DE 100 41 658 A1. The front-end optical system 7 for CGH illumination is used to convert the planar wave originating from the interferometer 3 into a spherical wave. The further structure of the test arrangement corresponds to the structure in FIG. 2 (same designations), with the difference that the outgoing planar wave strikes the front-end optical system 7 parallel to the optical axis originating from the interferometer 3.

Before the actual testing of the off-axis footprint 2, the errors of the interferometer 3, of the front-end optical system 7 and of the diffractive optical element 5 are determined by means of a spherical mirror 8, which is used instead of the footprint 2, in the zeroth order of diffraction of the CGH 5′, as illustrated in FIG. 4.

There are two possibilities for this. The first possibility would be to qualify the spherical mirror 8 with a standard method, all of the interferometer errors then being known. In the case of the second possibility, an incorporated spherical mirror is used with which, by means of the cited rotational averaging method, the non-rotationally symmetrical interferometer errors can be determined in absolute terms. Therefore, all the refractive system parts 3, 7 and the reference surface 4 are calibrated accurately.

From measurements on specific CGHs using a different absolute measurement method, which is described in DE 101 25 785 A1, it is known that CGH structures can be written very accurately with modern writers. Therefore, it can be assumed that, in the useful order of diffraction different from zero (m≠0), the aspheric test wave exhibits negligibly small errors.

If the errors of the interferometer 3, the front-end optical system 7 and of the diffractive optical element 5 are known, then, as illustrated in FIG. 5, the off-axis footprint 2 can be adjusted accurately instead of the spherical mirror 8. The errors from the off-axis footprint 2 which are rotationally symmetrical with respect to the parent 1 now appear as non-rotationally symmetrical errors. Since the non-rotationally symmetrical errors of the interferometer 3 are likewise known, non-rotationally symmetrical errors from the footprint 2 can then be measured accurately.

Here, it is important for the measurement of the footprint 2 that, from the non-rotationally symmetrical footprint errors with respect to the interferometer axis, it is necessary to draw conclusions about the rotationally symmetrical errors of the parent 1, since the latter are to be determined.

All the measurements of the off-axis footprint 2 are carried out in an order of diffraction different from zero (m≠0).

When illumination of the CGH 5′ is carried out with a spherical wave, it is advantageous that the radius of curvature of the spherical wave can be chosen such that the line density of the CGH 5′ lies in an advantageous range. The line density of the CGH 5′ can, for example, be kept so low that the CGH 5′ remains capable of being written sufficiently accurately by scalar methods and rigorous disruptive effects do not occur to a noticeable extent.

The CGH 5′ can be designed here as a chromium mask, that is to say as an amplitude hologram or else as a phase hologram. The latter embodiment leads to a higher diffraction efficiency, it being possible for a substantially higher contrast to be achieved in the interferogram.

Since final asphere adjustment leads to additional aberrations in the interferogram, it is expedient to adjust the aspherical footprint 2 very accurately relative to the test structure and to ensure its state of adjustment precisely. This can be done, for example, by means of highly accurate mechanical mounting techniques or by measuring the asphere position relative to the test structure.

The aberrations caused by adjustment inaccuracies can also be eliminated mathematically to a certain extent, for example in accordance with the method published by T. Dresel, N. Lindlein and J. Schwider in Optik 112 No. 7 (2001), pp. 304-308.

Since the diffraction by the CGH 5′ depends to a great extent on the wavelength of the light, it may be advantageous to use a frequency-stabilized laser and to determine the refractive index n_{L} of the air accurately by measuring air pressure and air temperature. It would also be possible to flush the test structure with nitrogen or helium in order to increase the measurement accuracy.

If the CGH 5′ is illuminated with a spherical wave, the front-end optical system 7 can be of aplanar design. Maladjustment coma can therefore be avoided, so that the coma on the footprint 2 can be determined more accurately.

A further advantage of this test arrangement is that, for the diffractive optical element 5, even in the case of elevated EUVL aspheres, only the size of the asphere footprint 2 actually fabricated is needed.

1. A system for interferometric fit testing of a specimen having an aspherical surface in reflection, the specimen being a segment (footprint) of a rotationally symmetrical basic body (parent), comprising an interferometer and a diffractive optical element (DOE), wherein an optical axis of the interferometer in the beam direction behind the diffractive optical element and an axis of rotation of the basic body form an angle that differs from zero, and the diffractive optical element being designed in such a way that the rays produced by the interferometer and falling into the diffractive optical element strike the specimen perpendicularly and from there run back in themselves.

2. The system as claimed in claim 1, wherein, between the interferometer and the diffractive optical element, there is a reference surface for producing a reference wave required for an interferogram, non-rotationally symmetrical interferometer errors being determined before the fit testing, after which the specimen is measured in an order of diffraction differing from zero (m≠0), the non-rotationally symmetrical errors of the specimen with respect to the optical axis of the interferometer being used to draw conclusions about the rotationally symmetrical errors of the basic shape.

3. The system as claimed in claim 1, wherein the wave striking a CGH of the diffractive optical element is provided as a planar wave.

4. The system as claimed in claim 3, wherein the test wave strikes the diffractive optical element at an angle.

5. The system as claimed in claim 1, wherein the wave striking a CGH of the diffractive optical element is provided as a spherical wave.

6. The system as claimed in claim 5, wherein a refractive front-end optical system is provided between the reference surface and the diffractive optical element.

7. The system as claimed in claim 6, wherein the refractive front-end optical system is of aplanar design.

8. The system as claimed in claim 3, wherein the CGH is formed as a chromium mask.

9. The system as claimed in claim 5, wherein the CGH is formed as a chromium mask.

10. The system as claimed in claim 8 or 9, wherein the CGH is designed as an amplitude hologram or as a phase hologram.

11. The system as claimed in claim 1, wherein the light source used is a frequency-stabilized laser.

12. The system as claimed in claim 1 or 10, wherein a current light wavelength is determined by a wavelength measuring instrument or indirectly via a determination of air temperature, air pressure or atmospheric humidity, and measurement errors caused by deviations from the desired value are eliminated from the measured result.

13. The system has claimed in claim 5, wherein a line density of the CGH can be chosen such that the CGH can be written sufficiently accurately by scalar optical diffraction methods.

14. A system for the interferometric fit testing of a specimen having an aspherical surface in reflection, the specimen being a segment (footprint) of a rotationally symmetrical basic body (parent), comprising an interferometer and a diffractive optical element (DOE), wherein an optical axis of the interferometer in the beam direction behind the diffractive optical element and an axis of rotation of the basic body form an angle that differs from zero, the diffractive optical element being designed in such a way that the rays produced by the interferometer and falling into the diffractive optical element strike the specimen perpendicularly and from there run back in themselves and, to determine the non-rotationally symmetrical interferometer errors in the zeroth order of diffraction, a planar plate is provided as specimen.

15. The system as claimed in claim 14, wherein, between the interferometer and the diffractive optical element, there is a reference surface for producing a reference wave required for an interferogram, non-rotationally symmetrical interferometer errors being determined before the fit testing, after which the specimen is measured in an order of diffraction differing from zero (m≠0), the non-rotationally symmetrical errors of the specimen with respect to the optical axis of the interferometer being used to draw conclusions about the rotationally symmetrical errors of the basic shape.

16. The system as claimed in claim 14, wherein the wave striking a CGH of the diffractive optical element is provided as a planar wave.

17. The system as claimed in claim 16, wherein the test wave strikes the diffractive optical element at an angle.

18. A system for the interferometric fit testing of a specimen having an aspherical surface in reflection, the specimen being a segment (footprint) of a rotationally symmetrical basic body (parent), comprising an interferometer and a diffractive optical element (DOE), wherein an optical axis of the interferometer in the beam direction behind the diffractive optical element and an axis of rotation of the basic body form an angle that differs from zero, the diffractive optical element being designed in such a way that the rays produced by the interferometer and falling into the diffractive optical element strike the specimen perpendicularly and from there run back in themselves and, to determine the non-rotationally symmetrical interferometer errors in the zeroth order of diffraction, a spherical mirror is provided as specimen.

19. The system as claimed in claim 18, wherein, between the interferometer and the diffractive optical element, there is a reference surface for producing a reference wave required for an interferogram, non-rotationally symmetrical interferometer errors being determined before the fit testing, after which the specimen is measured in an order of diffraction differing from zero (m≠0), the non-rotationally symmetrical errors of the specimen with respect to the optical axis of the interferometer being used to draw conclusions about the rotationally symmetrical errors of the basic shape.

20. The system as claimed in claim 18, wherein the wave striking a CGH of the diffractive optical element is provided as a spherical wave.

21. The system as claimed in claim 20, wherein the test wave strikes the diffractive optical element at an angle.

22. The system as claimed in claim 21, wherein a refractive front-end optical system is provided between the reference surface and the diffractive optical element.

23. The system as claimed in claim 22, wherein the refractive front-end optical system is of aplanar design.

24. A system for the interferometric fit testing of a specimen having an aspherical surface in reflection, the specimen being a segment (footprint) of a rotationally symmetrical basic body (parent) for a mirror optical system in EUV-lithography, comprising an interferometer and a diffractive optical element (DOE), wherein an optical axis of the interferometer in the beam direction behind the diffractive optical element and an axis of rotation of the basic body form an angle that differs from zero, and the diffractive optical element being designed in such a way that rays produced by the interferometer and falling into the diffractive optical element strike the specimen perpendicularly and from there run back in themselves.

25. The system as claimed in claim 23, wherein, between the interferometer and the diffractive optical element, there is a reference surface for producing a reference wave required for the interferogram, non-rotationally symmetrical interferometer errors being determined before the fit testing, after which the specimen is measured in an order of diffraction differing from zero (m≠0), the non-rotationally symmetrical errors of the specimen with respect to the optical axis of the interferometer being used to draw conclusions about the rotationally symmetrical errors of the basic shape.
